(19) United States
(12) Patent Application Publication
(10) Pub. No.: US 2026/0321042 A1
(43) Pub. Date: Oct. 15, 2026

(54) SEMANTIC SMOOTHING FILTER DEVICE AND METHOD

(71) Applicants: HYUNDAI MOTOR COMPANY, Seoul (KR); Kia Corporation, Seoul (KR)

(72) Inventors: Kyungzun RIM, Hwaseong-si (KR); Jaeseon KIM, Hwaseong-si (KR); Yeongmin SONG, Hwaseong-si (KR)

(21) Appl. No.: 19/425,286

(22) Filed: Dec. 18, 2025

(30) Foreign Application Priority Data
Apr. 9, 2025 (KR) 10-2025-0045980

(51) Int. Cl. G06V 20/70; G06T 5/20; G06T 7/12

(52) U.S. Cl. CPC G06V 20/70; G06T 5/20; G06T 7/12

(57) ABSTRACT

A semantic smoothing filter device comprises one or more memory devices configured to store a program code, and one or more processors configured to execute the program code to perform operations. The operations comprise receiving a labeled point cloud through semantic segmentation for an RGB image, generating a filtered height map by determining final height information for each cell based on topographical information and semantic information, and generating a semantic local map by using odometry, the labeled point cloud, and the filtered height map.

### CROSS-REFERENCE TO RELATED APPLICATION

This application claims priority to and the benefit of Korean Patent Application No. 10-2025-0045980 filed with the Korean Intellectual Property Office on Apr. 9, 2025, the entire contents of which are incorporated herein by reference.

### TECHNICAL FIELD

The present disclosure relates to a semantic smoothing filter device and a semantic smoothing filter method, and more particularly, to a semantic smoothing filter device and a semantic smoothing filter method for searching a drivable area of a robot.

### BACKGROUND

Since local mapping technology involves accumulating spatial information using odometry and identifying a drivable area based on the accumulated data, the accuracy of the resulting local map is highly dependent on the precision of the odometry.

A geometric smoothing filter is a filter designed to preserve structure features while gently deforming topography or 3D shape data. The geometric smoothing filter reduces noise by averaging adjacent points through averaging-based smoothing, and further refines the result by applying weighted averages based on distance through weight-based smoothing.

However, when there is noise in the odometry values used by the geometric smoothing filter, this noise propagates into the height values of the local map, making it difficult to distinguish between actual terrain variation and noise.

In such cases, relying solely on geometric criteria such as inclination angle or peripheral height differences may be insufficient to accurately identify and suppress noise.

### SUMMARY

The present disclosure is directed to a semantic smoothing filter device and a semantic smoothing filter method, which find a drivable area accurately even though there is noise in odometry, by utilizing semantic segmentation to reduce an influence of the odometry.

The present disclosure is also directed to a semantic smoothing filter device and a semantic smoothing filter method, which determine whether to use a height value of a smoothed height map or whether to use a height value of a raw height map when determining a height value of each cell to reduce noise.

The present disclosure is also directed to a semantic smoothing filter device and a semantic smoothing filter method, which determine whether to use the height value of the smoothed height map or whether to use the height value of the raw height map based on a mask value, and, at this time, use both a topographical information filter mask and a semantic filter mask.

According to one aspect of the present disclosure, a semantic smoothing filter device can include one or more memory devices configured to store a program code, and one or more processors configured to execute the program code to perform operations. The operations can include receiving a labeled point cloud through semantic segmentation for an RGB image, generating a filtered height map by determining final height information for each cell based on topographical information and semantic information, and generating a semantic local map by using odometry, the labeled point cloud, and the filtered height map.

In some implementations, receiving the labeled point cloud through the semantic segmentation can include generating the labeled point cloud through the semantic segmentation, and generating the labeled point cloud through the semantic segmentation can include creating a point cloud based on a robot center axis by using compute unified device architecture (CUDA) batch inference, and providing label information obtained from a result through the semantic segmentation for each point to generate the labeled point cloud. In some implementations, generating the filtered height map can include selecting between a first height map including initially provided first height information and a second height map including filtered second height information.

In some examples, selecting between the first height map and the second height map can include generating the second height map by applying a Gaussian filter to the first height map. In some implementations, generating the filtered height map can include generating a topographical information filter mask based on initial height information, generating a semantic information filter mask based on a label, combining the topographical information filter mask and the semantic information filter mask to generate an integrated mask, and determining the final height information by using the integrated mask. In some examples, generating the topographical information filter mask can include calculating a first mask value for each cell based on a slope and a height standard deviation derived from the initial height information.

In some implementations, generating the semantic information filter mask can include generating a label map based on the label, and generating the label map based on the label can include checking respective labels of points included in each cell, and storing the label that appears most frequently as the representative label for the corresponding cell. In some examples, generating the semantic information filter mask can include determining a second mask value for each cell based on whether the representative label corresponds to at least one predetermined specific label.

In some implementations, generating the integrated mask can include determining a third mask value by performing a logical AND operation between the topographical information filter mask and the semantic information filter mask. In some examples, determining the final height information can include selecting, based on the third mask value, either the first height information or the second height information obtained by applying a Gaussian filter to the first height information.

According to another aspect of the present disclosure, a semantic smoothing filter method performed by a computing device including a processor and a memory can include receiving, by the processor, a labeled point cloud through semantic segmentation for an RGB image, generating, by the processor, a filtered height map by determining final height information for each cell based on topographical information and semantic information, and generating, by the processor, a semantic local map by using odometry, the labeled point cloud, and the filtered height map.

In some implementations, receiving the labeled point cloud through the semantic segmentation can include generating, by the processor, the labeled point cloud through the semantic segmentation, and generating the labeled point cloud through the semantic segmentation can include creating, by the processor, a point cloud based on a robot center axis by using compute unified device architecture (CUDA) batch inference, and providing label information obtained from a result through the semantic segmentation for each point to generate the labeled point cloud. In some implementations, generating the filtered height map can include selecting between a first height map including initially provided first height information and a second height map including filtered second height information.

In some examples, selecting between the first height map and the second height map can include generating, by the processor, the second height map by applying a Gaussian filter to the first height map. In some implementations, generating the filtered height map can include generating, by the processor, a topographical information filter mask based on initial height information, generating, by the processor, a semantic information filter mask based on a label, combining the topographical information filter mask and the semantic information filter mask to generate an integrated mask, and determining, by the processor, the final height information by using the integrated mask.

In some examples, generating the topographical information filter mask can include calculating, by the processor, a first mask value for each cell based on a slope and a height standard deviation derived from the initial height information. In some implementations, generating the semantic information filter mask can include generating, by the processor, a label map based on the label, and generating the label map based on the label can include checking, by the processor, respective labels of points included in each cell, and storing the label that appears most frequently as the representative label for the corresponding cell. In some examples, generating the semantic information filter mask can include determining, by the processor, a second mask value for each cell based on whether the representative label corresponds to at least one predetermined specific label.

In some implementations, generating the integrated mask can include determining, by the processor, a third mask value by performing a logical AND operation between the topographical information filter mask and the semantic information filter mask. In some examples, determining the final height information can include selecting, based on the third mask value, either the first height information or the second height information obtained by applying a Gaussian filter to the first height information.

### BRIEF DESCRIPTION OF THE DRAWINGS

FIG. 1 is a diagram illustrating an example of a semantic smoothing filter system.

FIG. 2 is a block diagram illustrating an example of a semantic segmentation module of FIG. 1.

FIG. 3 is a block diagram illustrating an example of a semantic local mapping module of FIG. 1.

FIG. 4 is a block diagram illustrating an example of a semantic smoothing filter device.

FIGS. 5 and 6 are flowcharts illustrating an example of a semantic smoothing filter method.

FIGS. 7 to 9 are flowcharts illustrating an example of a semantic smoothing filter method.

FIG. 10 is a diagram illustrating an example a computing device.

### DETAILED DESCRIPTION

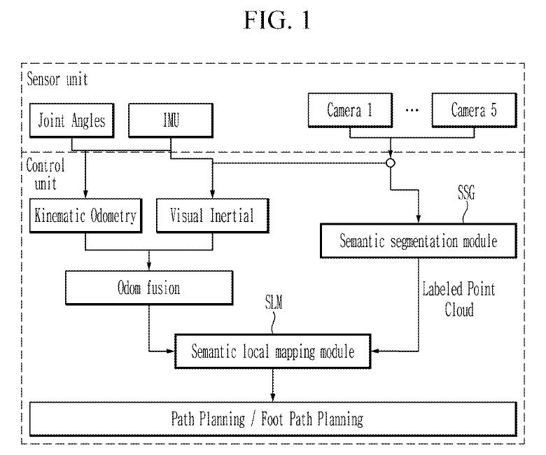

FIG. 1 is a diagram illustrating an example of a semantic smoothing filter system.

Referring to FIG. 1, the semantic smoothing filter system can include a sensor unit and a control unit connected through a network.

The sensor unit can include an internal measurement unit (IMU) and a plurality of cameras.

The sensor unit can collect sensor information by using a sensor including the IMU and the plurality of cameras attached to a robot, and deliver the collected sensor information to the control unit.

The control unit can include a semantic segmentation module SSG and a semantic local mapping module SLM.

The control unit can receive the sensor information from the sensor unit to generate a local driving map and ultimately generate a route plan of the robot.

The control unit can calculate each of kinematic odometry and visual inertial odometry based on IMU sensing information received from the IMU, and calculate the odometry by combining the calculated kinematic odometry and visual inertial odometry.

The semantic segmentation module SSG can generate a labeled point cloud based on camera information received from the plurality of cameras.

The semantic segmentation module SSG can provide the labeled point cloud to the semantic local mapping module SLM.

The semantic local mapping module SLM can generate a semantic local map based on the odometry and the labeled point cloud.

The semantic local map can refer to a map for helping a robot or an autonomous vehicle understand and navigate a surrounding environment. In some implementations, the semantic local map does not merely represent a physical structure, but also includes semantic information about objects in an environment.

The control unit can establish a driving route plan of the robot using the semantic local map.

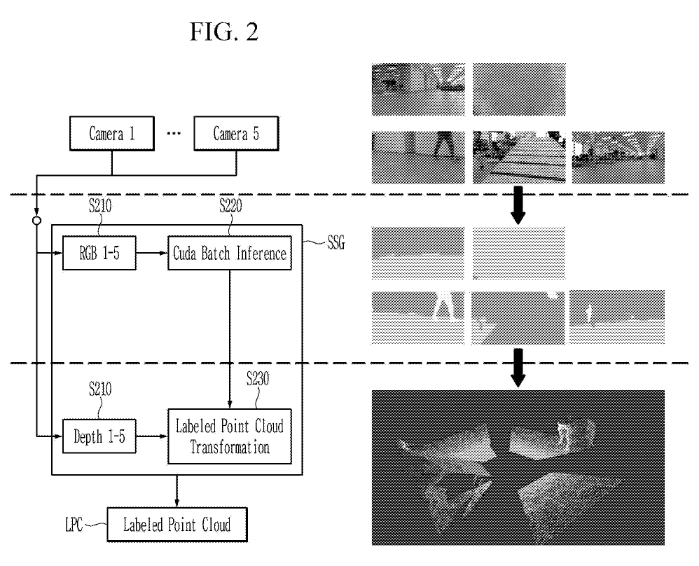

FIG. 2 is a block diagram illustrating an example of a semantic segmentation module of FIG. 1.

FIG. 2 illustrates an exemplary process in which the semantic segmentation module generates the labeled point cloud.

The semantic segmentation module SSG can receive an RGB image collected through the cameras as an input and label each pixel with one of three types of “person”, “drivable area”, and “obstacle” (step S210).

The semantic segmentation module SSG can use compute unified device architecture (CUDA) batch inference to increase a labeling speed (step S220).

The CUDA batch inference can refer to a process of simultaneously inferring data on a batch-by-batch basis with a GPU using a CUDA platform.

The CUDA batch inference can be used in deep learning and machine learning applications that seek to accelerate an inference process by utilizing a parallel processing capability of the GPU.

For example, the semantic segmentation module SSG can generate a point cloud based on a robot center axis by using four pieces of information of camera intrinsic, camera extrinsic, and depth image, and generate a labeled point cloud LPC by putting label information obtained from a semantic segmentation result together for each point (step S230).

For example, the semantic segmentation module SSG can generate the labeled point cloud LPC labeled in real time for five pictures RGBs 1 to 5 and Depths 1 to 5.

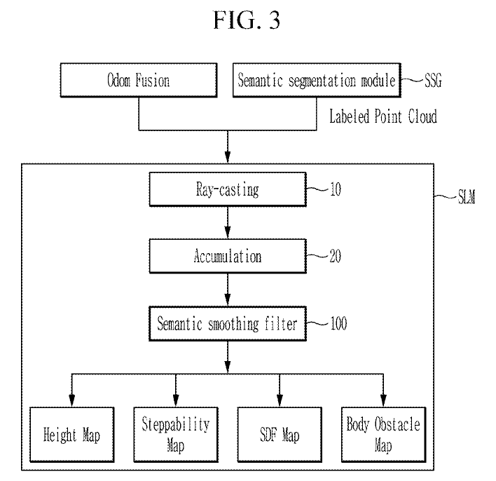

FIG. 3 is a block diagram illustrating an example of a semantic local mapping module of FIG. 1.

The semantic local mapping module SLM can receive the labeled point cloud as an input from the odometry and the semantic segmentation module SSG, and search a drivable area of the robot.

Referring to FIG. 3, the semantic local mapping module SLM can include a ray-casting module 10, an accumulation module 20, and a semantic smoothing filter device 100.

The ray-casting module 10 can determine whether a robot obstacle is located at the same position or is moved to a different position in existing local map information by utilizing a currently received labeled point cloud, and remove obstacle information from the local map when the robot obstacle is moved.

The accumulation module 20 can utilize the odometry information to transfer robot reference labeled point cloud information received as a current input to a map coordinate system, and update height information of each cell in the local map.

The semantic smoothing filter device 100 can utilize the geometric smoothing filter and the semantic smoothing filter method to smooth the map to reduce a problem caused by noise of the odometry and the sensor information in the accumulation module 20.

For example, the semantic smoothing filter device 100 can utilize the semantic segmentation result to generate an accurate semantic local map so as to stably search for the drivable area when searching for the drivable area of the robot using an RGBD camera.

Since local mapping accumulates information by using the odometry and finds the drivable area based on the accumulated information, a mapping result may be greatly affected by odometry accuracy.

The semantic smoothing filter device 100 can generate a filtered height map to find the drivable area accurately even if there is the noise in the odometry by utilizing semantic segmentation to reduce the influence of the odometry.

The filtered height map can be generated by determining final height information for each cell based on topographical information and semantic information.

To determine the final height information, the semantic smoothing filter device 100 can generate a topographical information filter mask based on initial height information, generate a semantic information filter mask based on label information, and combine the two masks to generate an integrated mask.

The semantic information filter mask can be generated by checking the labels of points included in each cell and storing the label that appears most frequently as the representative label for the corresponding cell.

The final height information can be selected based on the integrated mask between first height information and second height information obtained by applying a Gaussian filter to the first height information.

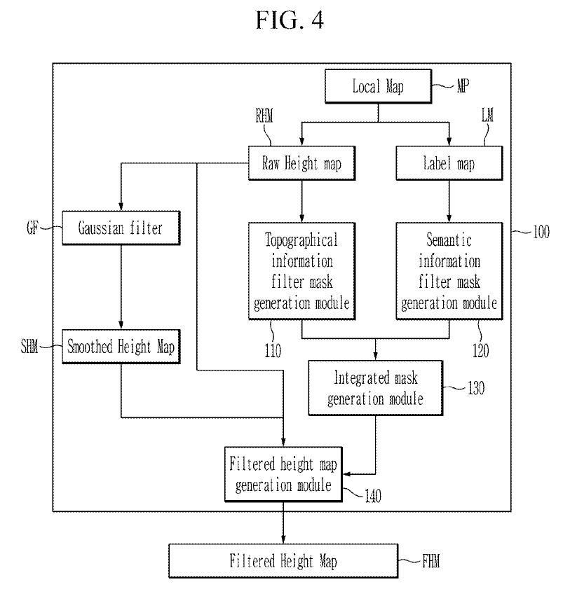

FIG. 4 is a block diagram illustrating an example of a semantic smoothing filter device (or a semantic smoothing filter).

The semantic smoothing filter device 100 can execute program codes or instructions loaded on one or more memory devices through one or more processors.

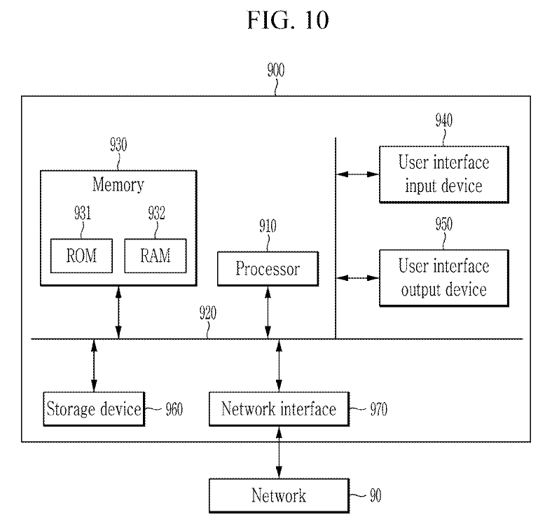

For example, the semantic smoothing filter device 100 can be implemented as a computing device 900 described below in relation to FIG. 10. In some implementations, one or more processors can correspond to a processor 910 of the computing device 900, and one or more memory devices can correspond to a memory 930 of the computing device 900.

The program codes or instructions can be executed by one or more processors to generate a filtered height map by determining final height information for each cell based on topographical information and semantic information.

The semantic smoothing filter device 100 can reduce noise of a raw height map RHM initially provided.

To reduce the noise, when the height values of the smoothed height map (SHM) can be used as the height values of all cells, necessary information such as the obstacle may disappear, so it is necessary to accurately make the mask to prevent the information from disappearing.

The semantic smoothing filter device 100 can generate a filtered height map FHM that selects between a first height map RHM including initially provided first height information and a second height map SHM including filtered second height information.

The semantic smoothing filter device 100 can generate the second height map SHM by applying a Gaussian filter to the first height map RHM.

The Gaussian filter GF can use a library implemented by a method of convolution of a Gaussian kernel value for each cell.

Referring to FIG. 4, the semantic smoothing filter device 100 can include a topographical information filter mask generation module 110, a semantic information filter mask generation module 120, an integrated mask generation module 130, and a filtered height map generation module 140.

The topographical information filter mask generation module 110 can receive an initial height map RHM from an initially provided local map MP.

The topographical information filter mask generation module 110 can generate a topographical information filter mask based on initial height information stored in the initial height map RHM.

The topographical information filter mask generation module 110 can calculate a first mask value for each cell based on a slope and a height standard deviation derived from the initial height information.

The semantic information filter mask generation module 120 can generate a semantic information filter mask based on a label stored in each cell.

The semantic information filter mask generation module 120 can generate a label map LM including label information based on the label.

Alternatively, the semantic information filter mask generation module 120 can receive the label map LM from the initially provided local map MP.

The semantic information filter mask generation module 120 can check the labels of points included in each cell, and store the label that appears most frequently as the representative label for the corresponding cell.

The semantic information filter mask generation module 120 can determine a second mask value based on whether the label of each cell corresponds to at least one predetermined specific label by using the semantic information filter mask.

For example, the semantic information filter mask generation module 120 can determine a second mask value that is 1 if the label of each cell of the label map LM is not “person” or “obstacle” and 0 otherwise.

The integrated mask generation module 130 can combine the topographical information filter mask and the semantic information filter mask to generate an integrated mask.

The integrated mask generation module 130 can perform a logical AND operation between the topographical information filter mask and the semantic information filter mask to determine a third mask value of the integrated mask.

The filtered height map generation module 140 can generate a filtered height map FHM that determines final height information using the integrated mask.

The filtered height map generation module 140 can receive the first height information from the initial first height map RHM and receive the second height information from the second height map SHM filtered through the Gaussian filter GF.

The filtered height map generation module 140 can generate a filtered height map FHM that selects, based on the third mask value, either the first height information or the second height information obtained by applying the Gaussian filter to the first height information.

The filtered height map generation module 140 can generate the filtered height map FHM that uses a cell height value of the second height map SHM when the third mask value is 1, and uses the height value of the first height map RHM when the third mask value is 0.

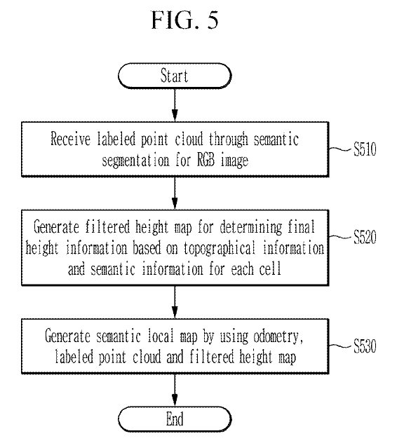

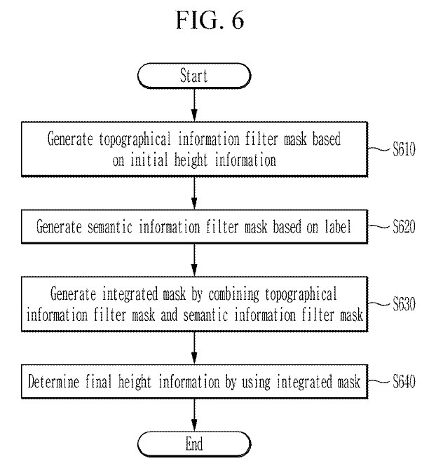

FIGS. 5 and 6 are flowcharts illustrating an example of a semantic smoothing filter method.

In FIG. 5, the semantic smoothing filter device 100 can receive a labeled point cloud through semantic segmentation with respect to an RGB image (step S510).

The semantic smoothing filter device 100 can receive the labeled point cloud as an input from the semantic segmentation module SSG (see FIG. 3).

In addition, the semantic smoothing filter device 100 can generate the labeled point cloud through the semantic segmentation.

In some implementations, the semantic smoothing filter device 100 can create a point cloud based on a robot center axis by using CUDA batch inference, and provide label information obtained from a result through the semantic segmentation for each point to generate the labeled point cloud.

The semantic smoothing filter device 100 can generate a filtered height map by determining final height information for each cell based on topographical information and semantic information (step S520).

The semantic smoothing filter device 100 can generate a semantic local map using odometry, the labeled point cloud, and the filtered height map (step S530).

In FIG. 6, the semantic smoothing filter device 100 can generate a topographical information filter mask based on initial height information (step S610).

The semantic smoothing filter device 100 can calculate a first mask value for each cell based on a slope and a height standard deviation derived from the initial height information.

The semantic smoothing filter device 100 can generate a semantic information filter mask based on a label (step S620).

The semantic smoothing filter device 100 can check the labels of points included in each cell, and store the label that appears most frequently as the representative label for the corresponding cell.

The semantic smoothing filter device 100 can determine a second mask value of the semantic information filter mask based on whether the representative label of each cell corresponds to at least one predetermined specific label by using the semantic information filter mask.

The semantic smoothing filter device 100 can combine the topographical information filter mask and the semantic information filter mask to generate an integrated mask (step S630).

The semantic smoothing filter device 100 can logical AND operation between the first mask value of the topographical information filter mask and the second mask value of the semantic information filter mask to determine a third mask value of the integrated mask.

The semantic smoothing filter device 100 can determine final height information by using the integrated mask (step S640).

The semantic smoothing filter device 100 can generate a filtered height map based on a first height map initially provided, a second height map filtered through a Gaussian filter, and an integrated mask.

The filtered height map can determine whether to use the first height map or the second height map in the process of calculating the final height information based on the third mask value.

For example, the semantic smoothing filter device 100 can select, based on the third mask value, either the first height information of the first height map or the second height information of the second height map obtained by applying a Gaussian filter to the first height information.

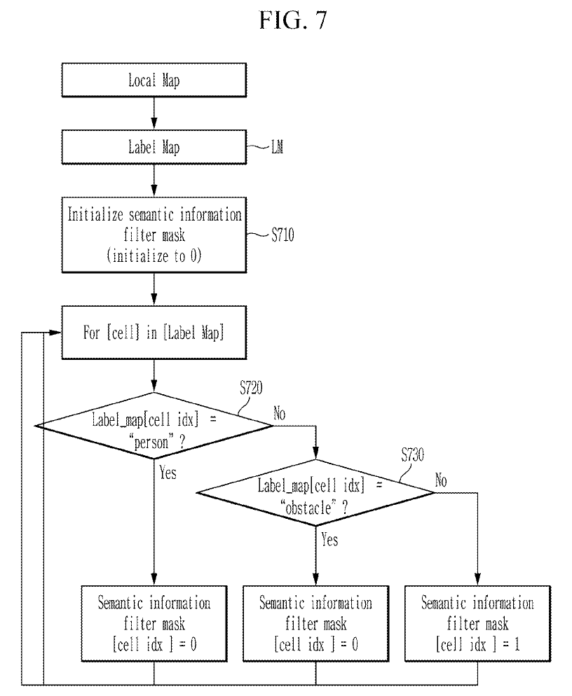

FIGS. 7 to 9 are flowcharts illustrating an example of a semantic smoothing filter method.

FIG. 7 is a flowchart illustrating an example of a method for generating a semantic information filter mask.

In FIG. 7, the semantic smoothing filter device 100 can create a label map by utilizing a label stored in each cell of a local map LM, and generate a semantic information filter mask by checking a label map LM value of each cell.

The semantic smoothing filter device 100 can initialize the semantic information filter mask (step S710).

For each cell of the label map, the semantic smoothing filter device 100 can collect points corresponding to each cell, and check labels of points entering each cell.

As a result of checking the labels of the points entering each cell, the semantic smoothing filter device 100 can store the label that appears most frequently among the three labels (for example, person, obstacle, and drivable area) as the representative label of the corresponding cell.

When the representative label of each cell is “person” or “obstacle”, the semantic smoothing filter device 100 can determine the mask value of the semantic information filter mask of the corresponding cell to be 0, and otherwise determine the mask value to be 1.

For example, the semantic smoothing filter device 100 can first determine whether the representative label of the cell is the person (step S720).

The semantic smoothing filter device 100 can determine the mask value to be 0 when the representative label of the cell is the person.

When it is determined that the representative label of the cell is not the person, the semantic smoothing filter device 100 can determine whether the representative label of the corresponding cell is the obstacle (step S730).

The semantic smoothing filter device 100 can determine the mask value to be 0 when the representative label of the cell is determined to be the obstacle, and otherwise determine the mask value to be 1.

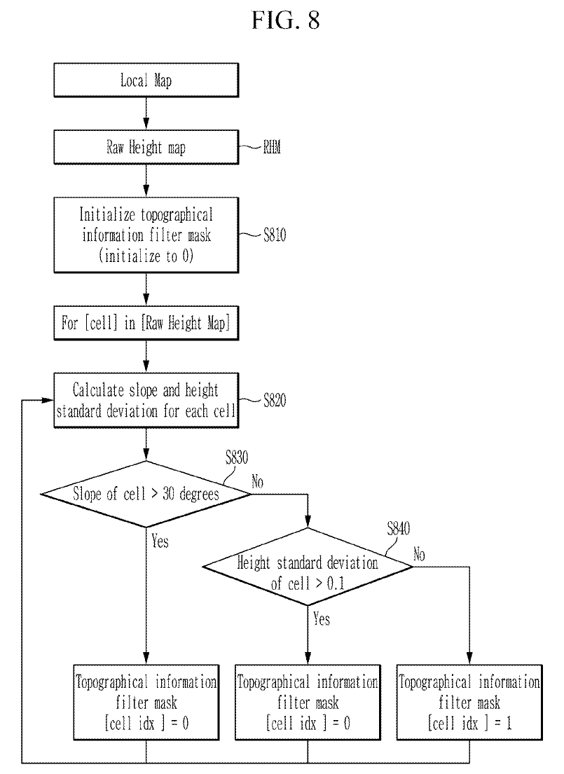

FIG. 8 is a flowchart illustrating an example of a method for generating a topographical information filter mask.

In FIG. 8, the semantic smoothing filter device 100 can generate a topographical information filter mask based on an initial height map.

The semantic smoothing filter device 100 can initialize a mask value of the topographical information filter mask to 0 (step S810).

The semantic smoothing filter device 100 can generate the topographical information filter mask by using a slope and a height standard deviation of a cell.

The semantic smoothing filter device 100 can obtain the slope and the height standard deviation of each cell by using a height value of an initial height maps RHM of nine cells around a reference cell (step S820).

When the slope of each cell is more than 30 degrees or the height standard deviation is more than 0.1, the semantic smoothing filter device 100 can store the mask value of the topographical information filter mask as 0, and otherwise determine the mask value as 1.

For example, the semantic smoothing filter device 100 can determine whether the slope of the cell is greater than 30 degrees (step S830).

The semantic smoothing filter device 100 can determine the mask value of the topographical information filter mask to be 0 when the slope of the cell is greater than 30 degrees.

When the slope of the cell is less than or equal to 30 degrees, the semantic smoothing filter device 100 can check the standard deviation of the height of the cell.

When it is determined that the slope of the cell is less than or equal to 30 degrees, the semantic smoothing filter device 100 can determine whether the standard deviation of the height of the cell is greater than 0.1 (step S840).

The semantic smoothing filter device 100 can determine the mask value to be 0 when the height standard deviation of the cell is greater than 0.1.

The semantic smoothing filter device 100 can determine the mask value of the topographical information filter mask to be 1 when the height standard deviation of the cell is less than or equal to 0.1.

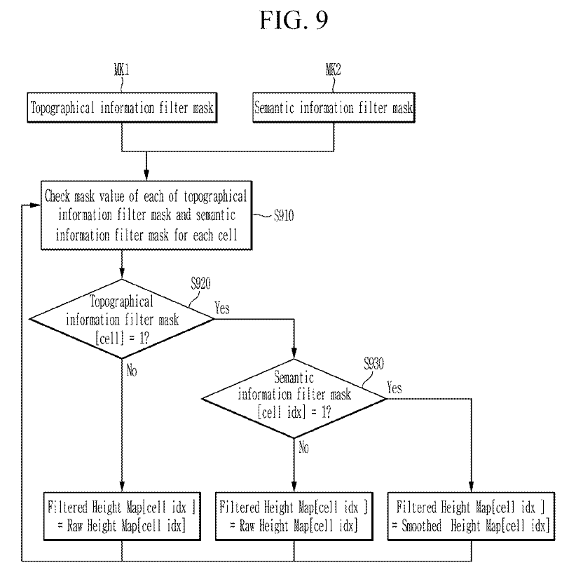

FIG. 9 is a flowchart illustrating an example of a method for generating a filtered height map.

In FIG. 9, the semantic smoothing filter device 100 may generate a filtered height map by using an AND operation between a topographical information filter mask MK1 and a semantic information filter mask MK2.

The semantic smoothing filter device 100 can check the first mask value of the topographical information filter mask MK1 and the second mask value of the semantic information filter mask MK2 for each cell (step S910).

The semantic smoothing filter device 100 can determine whether the first mask value of the topographical information filter mask is 1 (step S920).

The semantic smoothing filter device 100 can select the initial first height map as the filtered height map when the first mask value is not 1.

The semantic smoothing filter device 100 can determine whether the second mask value of the semantic information filter mask is 1 when the first mask value of the topographical information filter mask is 1 (step S930).

The semantic smoothing filter device 100 can select the initial first height map as the filtered height map when the second mask value is not 1.

The semantic smoothing filter device 100 can select the filtered second height map as the filtered height map when the second mask value is 1.

The semantic smoothing filter device 100 can determine the second height information of the second height map, obtained by applying a Gaussian filter to the first height map, as the final height information only when a third mask value—resulting from the AND operation between the first and second mask values—is 1.

For example, the semantic smoothing filter device 100 can use the second height value of the second height map as the final height value of the corresponding cell only when both the topographical information filter mask MK1 and the semantic information filter mask MK2 allow the use of the Gaussian-filtered height value.

FIG. 10 is a diagram illustrating an example of a computing device.

Referring to FIG. 10, the semantic smoothing filter device and the semantic smoothing filter method can be implemented by using a computing device 900.

The computing device 900 can include at least one of a processor 910, a memory 930, a user interface input device 940, a user interface output device 950, and a storage device 560 which communicate with one another through a bus 920. The computing device 900 can also include a network interface 970 electrically connected to a network 90

The network interface 970 can transmit or receive a signal to or from another entity through the network 90.

The processor 910 can be implemented as various types including a micro controller unit (MCU), an application processor (AP), a central processing unit (CPU), a graphic processing unit (GPU), and a neural processing unit (NPU), and can be an arbitrary semiconductor device that executes an instruction stored in the memory 930 or the storage device 960. The processor 910 can be configured to implement the functions and methods described above in relation to FIGS. 1 to 9.

The memory 930 and the storage device 960 can include various types of volatile or non-volatile storage media. For example, the memory can include a read only memory (ROM) 931 and a random access memory (RAM) 932. In some implementations, the memory 930 can be positioned inside or outside the processor 910 and connected to the processor 910 by various well-known means.

In some implementations, at least some components or functions of the semantic smoothing filter device and the semantic smoothing filter method can be implemented as a program or software executed by the computing device 900 or the program or software can be stored in a computer readable medium.

In some implementations, at least some components or functions of the semantic smoothing filter device and the semantic smoothing filter method can be implemented by using hardware or a circuit of the computing device or as separate hardware or a separate which can be electrically connected to the computing device.

What is claimed is:

1. A semantic smoothing filter device comprising:
one or more memory devices configured to store a program code; and
one or more processors configured to execute the program code to perform operations comprising:
receiving a labeled point cloud through semantic segmentation for an RGB image,
generating a filtered height map by determining final height information for each cell based on topographical information and semantic information, and
generating a semantic local map by using odometry, the labeled point cloud, and the filtered height map.

2. The semantic smoothing filter device of claim 1, wherein receiving the labeled point cloud through the semantic segmentation comprises generating the labeled point cloud through the semantic segmentation, and
wherein generating the labeled point cloud through the semantic segmentation comprises:
creating a point cloud based on a robot center axis by using compute unified device architecture (CUDA) batch inference, and
providing label information obtained from a result through the semantic segmentation for each point to generate the labeled point cloud.

3. The semantic smoothing filter device of claim 1, wherein generating the filtered height map comprises selecting between a first height map including initially provided first height information and a second height map including filtered second height information.

4. The semantic smoothing filter device of claim 3, wherein selecting between the first height map and the second height map includes generating the second height map by applying a Gaussian filter to the first height map.

5. The semantic smoothing filter device of claim 1, wherein generating the filtered height map comprises:
generating a topographical information filter mask based on initial height information,
generating a semantic information filter mask based on a label,
combining the topographical information filter mask and the semantic information filter mask to generate an integrated mask, and
determining the final height information by using the integrated mask.

6. The semantic smoothing filter device of claim 5, wherein generating the topographical information filter mask comprises calculating a first mask value for each cell based on a slope and a height standard deviation derived from the initial height information.

7. The semantic smoothing filter device of claim 5, wherein generating the semantic information filter mask comprises generating a label map based on the label, and
wherein generating the label map based on the label comprises:
checking respective labels of points included in each cell, and
storing the label that appears most frequently as a representative label for the corresponding cell.

8. The semantic smoothing filter device of claim 7, wherein generating the semantic information filter mask comprises:
determining a second mask value for each cell based on whether the representative label corresponds to at least one predetermined specific label.

9. The semantic smoothing filter device of claim 5, wherein generating the integrated mask comprises:
determining a third mask value by performing a logical AND operation between the topographical information filter mask and the semantic information filter mask.

10. The semantic smoothing filter device of claim 9, wherein determining the final height information comprises:
selecting, based on the third mask value, either first height information or second height information obtained by applying a Gaussian filter to the first height information.

11. A semantic smoothing filter method performed by a computing device including a processor and a memory, the semantic smoothing filter method comprising:
receiving, by the processor, a labeled point cloud through semantic segmentation for an RGB image;
generating, by the processor, a filtered height map by determining final height information for each cell based on topographical information and semantic information; and
generating, by the processor, a semantic local map by using odometry, the labeled point cloud, and the filtered height map.

12. The semantic smoothing filter method of claim 11, wherein receiving the labeled point cloud through the semantic segmentation comprises generating, by the processor, the labeled point cloud through the semantic segmentation, and
wherein generating the labeled point cloud through the semantic segmentation comprises:
creating, by the processor, a point cloud based on a robot center axis by using compute unified device architecture (CUDA) batch inference, and
providing label information obtained from a result through the semantic segmentation for each point to generate the labeled point cloud.

13. The semantic smoothing filter method of claim 11, wherein generating the filtered height map comprises selecting between a first height map including initially provided first height information and a second height map including filtered second height information.

14. The semantic smoothing filter method of claim 13, wherein selecting between the first height map and the second height map comprises generating, by the processor, the second height map by applying a Gaussian filter to the first height map.

15. The semantic smoothing filter method of claim 11, wherein generating the filtered height map comprises:
generating, by the processor, a topographical information filter mask based on initial height information,
generating, by the processor, a semantic information filter mask based on a label,
combining the topographical information filter mask and the semantic information filter mask to generate an integrated mask, and
determining, by the processor, the final height information by using the integrated mask.

16. The semantic smoothing filter method of claim 15, wherein:
generating the topographical information filter mask comprises calculating, by the processor, a first mask value for each cell based on a slope and a height standard deviation derived from the initial height information.

17. The semantic smoothing filter method of claim 15, wherein generating the semantic information filter mask comprises generating, by the processor, a label map based on the label, and
wherein generating the label map based on the label comprises:
checking, by the processor, respective labels of points included in each cell, and
storing the label that appears most frequently as a representative label for the corresponding cell.

18. The semantic smoothing filter method of claim 17, wherein generating the semantic information filter mask comprises:
determining, by the processor, a second mask value for each cell based on whether the representative label corresponds to at least one predetermined specific label.

19. The semantic smoothing filter method of claim 15, wherein generating the integrated mask comprises:
determining, by the processor, a third mask value by performing a logical AND operation between the topographical information filter mask and the semantic information filter mask.

20. The semantic smoothing filter method of claim 19, wherein determining the final height information comprises:
selecting, based on the third mask value, either first height information or second height information obtained by applying a Gaussian filter to the first height information.
